(19) United States
(12) Patent Application Publication
(10) Pub. No.: US 2003/0133425 A1
(43) Pub. Date: Jul. 17, 2003

(54) System and method for using CDMA mobile with GSM core infrastructure

(76) Inventors: Dhinakar Radhakrishnan, San Diego, CA (US); Eitan Yacobi, Zichron-Ya'akov (IL); Yoram Rimoni, Haifa (IL); Michael Green, Zichron Yaakov (IL)

Correspondence Address: QUALCOMM Incorporated, Attn: Patent Department, 5775 Morehouse Drive, San Diego, CA, 92121-1714, US

(21) Appl. No.: 10/076,831

(22) Filed: Feb. 14, 2002

Related U.S. Application Data
(60) Provisional application No. 60/350,829, filed on Jan. 17, 2002.
(60) Provisional application No. 60/354,086, filed on Feb. 1, 2002.

(51) Int. Cl. H04B 7/216

(52) U.S. Cl. 370/335; 370/342; 370/441

(57) ABSTRACT

A CDMA mobile station (MS) can be engaged with a GSM subscriber identity module (SIM) to authenticate the MS with a GSM core infrastructure using a CDMA radio access network (RAN) through a hybrid CDMA/GSM message switching center (MSC), such that use of the CDMA RAN with the existing GSM core advantageously is facilitated.

### RELATED APPLICATIONS

This application claims priority from both U.S. Provisional patent application entitled “Use of GSM Subscriber Identity Module (SIM) with a CDMA2000 Access Network”, Ser. No. 60/350,829 (attorney docket no. 020162P1) filed Jan. 17, 2002, and U.S. Provisional patent application entitled “Use of GSM Subscriber Identity Module (SIM) with a CDMA2000 Access Network”, attorney docket no. 020162P2 filed Feb. 1, 2002.

### FIELD OF THE INVENTION

The present invention relates generally to wireless communication systems, and more particularly to systems that use a CDMA radio access network with a GSM core network.

### BACKGROUND

Code division multiple access (CDMA) is a digital wireless technology that inherently has relatively greater bandwidth capacity, i.e., that inherently permits the servicing of more telephone calls per frequency band, than other wireless communication technologies. Moreover, the spread spectrum principles of CDMA inherently provide secure communications. U.S. Pat. No. 4,901,307, incorporated herein by reference, sets forth details of a CDMA system, which can be used to transmit both voice calls and non-voice computer data.

Despite the advantages of CDMA, other wireless systems exist that use other principles. For example, in much of the world GSM is used, which employs a version of time division multiple access.

Whether CDMA principles or other wireless principles are used, wireless communication systems can be thought of as having two main components, namely, the wireless radio access network (RAN) and the core infrastructure which communicates with the RAN and with external systems, such as the public switched telephone network (PSTN), the Internet (particularly although not exclusively for data calls), etc. The core infrastructures associated with the various wireless technologies can be very expensive, both in terms of hardware and in terms of developing communication protocols to support particularized, typically system-specific call switching, subscription and attendant authentication and call monitoring, and billing. Consequently, the communication protocols of one wireless system (in the case of GSM, GSM protocols, and in the case of CDMA such as cdma2000-1x, IS-41 protocols) may not be compatible with those of another system without expensively prohibitive alterations in the core infrastructure of one system or the other.

From the disclosure above, the present invention recognizes that it would be desirable to enable the use of a CDMA-based RAN, with its attendant advantages, with a GSM-based core infrastructure, because GSM is extant in much of the world. The present invention still further recognizes, in light of the above, the desirability of minimizing if not eliminating the need to modify the communication protocols of the GSM core infrastructure.

### SUMMARY OF THE INVENTION

A code division multiple access (CDMA) mobile station (MS) includes a radio circuit configured to communicate with a CDMA radio access network (RAN) using CDMA protocol. The MS also includes a subscriber circuit configured to communicate with a GSM subscriber identity module (SIM) to permit the MS to authenticate itself with a GSM core infrastructure. With this structure, use of the CDMA RAN with the GSM core infrastructure is facilitated.

In a preferred embodiment, the MS reads an International Mobile Subscriber Identity (IMSI) from the SIM and transmits the IMSI over the CDMA RAN in a registration message, or an origination message, or a page response message. If desired, the MS can display a service provider name, a mobile directory number, and other GSM related information items.

In a non-limiting embodiment the MS permits a user to use the MS only if the user inputs a predetermined verification value to the MS. Also, the preferred MS terminates a call upon removal of the SIM from the MS, and it also deletes subscriber information upon removal of the SIM from the MS. Preferably, the MS periodically checks for the presence of the SIM in the MS and terminates a call when the MS determines that the SIM is no longer engaged with the MS. The MS may use cdma2000 principles.

In another aspect, a method for facilitating the use of a CDMA RAN with a GSM core infrastructure includes engaging a SIM with a CDMA MS, and transmitting at least one IMSI stored on the SIM to an MSC using a CDMA RAN. Using the IMSI, the SIM is authenticated with a GSM core infrastructure. Based on the authentication, the MS with SIM can be registered with the MSC.

In still another aspect, a system for facilitating the use of a CDMA RAN with a GSM core infrastructure includes an MSC that communicates with the CDMA RAN using CDMA protocol. The MSC also communicates with the GSM core infrastructure using GSM protocol. An MS communicates with the CDMA RAN and has a registration in the GSM core infrastructure. A SIM is detachably engageable with the MS for authenticating the MS with the GSM core infrastructure.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system for facilitating communication using a CDMA radio access network and a GSM core infrastructure;

FIG. 2 is a flow chart showing the logic that is invoked when the subscriber identity module (SIM) is engaged with the CDMA mobile station (MS);

FIG. 3 is a flow chart showing the logic that is invoked when the SIM is removed from the MS; and

FIG. 4 is a flow chart showing the logic that is periodically invoked to check the presence of the SIM.

### DETAILED DESCRIPTION OF THE PREFERRED EMBODIMENT

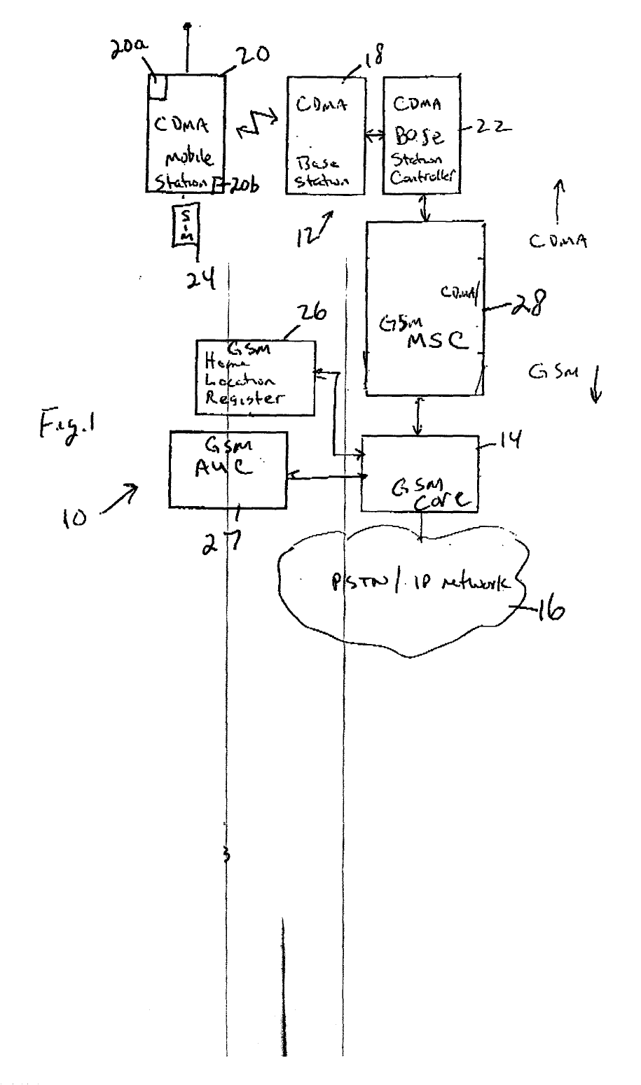

Referring initially to FIG. 1, a system is shown, generally designated 10, for facilitating communication, including voice and computer data communication, between a code division multiple access (CDMA) radio access network (RAN), generally designated 12, and a GSM core infrastructure 14. In turn, the GSM core infrastructure 14 can communicate with a public switched telephone network (PSTN) and/or a data network 16, such as the Internet.

As shown in FIG. 1, the CDMA RAN 12 supports wireless communication between one or more base stations (BTS) 18 and mobile stations (MS) 20. In accordance with CDMA principles known in the art, the BTS 18 can communicate with base station controllers (BSC) 22. The preferred CDMA RAN 12 shown in FIG. 1 uses cdma2000, and specifically uses either cdmaOne (IS-95), cdma2000 1x, cdma2000 3x, or cdma2000 high data rate (HDR) or 1xEVDO principles.

In one non-limiting embodiment the mobile station 20 is a mobile telephone made by Kyocera, Samsung, or other manufacturer that uses Code Division Multiple Access (CDMA) principles and CDMA over-the-air (OTA) communication air interfaces in conjunction with a radio circuit 20a to communicate with the CDMA RAN 12. The present invention, however, applies to other mobile stations such as laptop computers, wireless handsets or telephones, data transceivers, palm devices, or paging and position determination receivers. The mobile station 20 can be hand-held or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

In accordance with the present invention, a subscriber identity module (SIM) 24 is removably engageable with a subscriber circuit 20b in the MS 20. The SIM 24 is a smart card that includes a microprocessor and data storage to exchange data with the MS 20 using the subscriber circuit 20b. The preferred non-limiting SIM 24 stores the following information. At a master file level the SIM stores a SIM identification number.

At a GSM application file level the SIM 24 may store a language preference of the user, an International Mobile Subscriber Identity (IMSI) that functions as a user identification and also that identifies the user's service provider (i.e., the GSM core infrastructure 14), and a ciphering key. Moreover, the SIM 24 preferably stores an identification of a Public Land Mobile Network (PLMN) preferred by the user, and a search period for the selected PLMN. Also, the SIM 24 stores a maximum value of an accumulated call meter (ACM), which is the total number of call units for the current and preceding call, and a SIM service table that indicates which services are allocated to the user and activated. Additionally, the SIM 24 stores various group identifiers that identify groups of SIMs for SIM/MS association. Still further, the preferred SIM 24 stores a Service Provider name and a price per unit/currency table that is used to compute the cost of calls in a currency selected by the user.

In addition to the above data, the preferred SIM 24 also includes a broadcast message identifier that indicates the types of messages on the broadcast channel that the user wants to accept. Also, the SIM 24 may include broadcast control channel designations to aid the MS in quickly acquiring a GSM RAN, when one is available, as well as other GSM RAN-specific information. A non-limiting SIM 24 can also store a list of up to four PLMNs that the MS will not automatically attempt to access. In another embodiment, SIM 24 may store up to 8 PLMNs that the MS will not automatically attempt to access. The SIM 24 can further store location information, administrative data, and the phase identification of the SIM.

In addition, at the telecom level the preferred SIM 24 may store abbreviated dialing numbers/supplementary service control strings, fixed dialing numbers/supplementary service control strings, and short messages (SMS) received by the MS or to be transmitted by the MS. Still further, the preferred SIM 24 can include parameters of required network and bearer capabilities, mobile station international ISDN numbers related to the subscriber, and values of SMS header parameters. Status information related to SMS can also be stored, as can the last number dialed and various extensions of data for the above.

The preferred, non-limiting SIM 24 can also execute the following commands. It can select an input file, and provide status regarding, e.g., the current file directory in the SIM. The SIM 24 can also read and update strings of bytes and records, and seek for a user-defined pattern in a selected file. Also, the SIM 24 may perform increase access on a selected file.

The SIM 24 can also execute several commands related to the Card Holder Verification (CHV) feature, including verifying a CHV value presented by the MS, assigning a new CHV value, and enabling, disabling, and unblocking the CHV feature. The SIM 24 can also invalidate a user-selected file and rehabilitate a previously invalidated file. Preferably, the SIM 24 can execute an authentication algorithm with the GSM core infrastructure 14 and calculate an authentication cipher key in accordance with GSM authentication principles.

Turning to the GSM core infrastructure 14, among other components the GSM core infrastructure 14 can include or can access a home location register (HLR) 26 that contains subscriber data for users of the GSM core infrastructure 14. Also, the GSM core infrastructure 14 can include or can access an authentication center (AUC) 27. These components are used in accordance with GSM principles known in the art to authenticate the MS 20 with SIM 24.

A CDMA/GSM Mobile Switching Center (MSC) 28 interconnects the CDMA RAN 12 and the GSM core infrastructure 14. It is to be understood that the HLR 26 and AUC 27 can be connected directly to the MSC 28 if desired. In the preferred embodiment shown, the MSC 28 communicates using CDMA protocols with the CDMA RAN 12 in accordance with PDSN operation known in the CDMA art (for data) and in accordance with ANSI-41 operation (for voice). Moreover, the MSC 28 communicates with the GSM core infrastructure 14 using GSM protocols in accordance with GSM voice and GSM data (i.e., SGSN) operations known in the GSM art. Accordingly, use of the CDMA RAN 12 with the GSM core infrastructure 14 is facilitated without modifying the GSM core infrastructure 14 to use CDMA protocols, such as ANSI-41, but rather to use its own existing protocols.

FIG. 2 shows the logic that is followed upon insertion of the SIM 24 into the MS 20. Commencing at block 30, the SIM 24 is reset and necessary operational parameters stored in the SIM are negotiated. Proceeding to block 32 the SIM identification is retrieved and compared to a prior SIM identification to determine that the SIM that has been inserted into the MS 20 is a new SIM requiring the following steps. At decision diamond 34 it is determined whether CHV has been enabled, and if so, the user is prompted to enter a CHV value at block 36. The value is passed to the SIM at block 38 to obtain SIM file access for the subsequent steps, assuming the value is determined to be valid by the SIM. If the value is not valid the logic ends.

From block 38 or from decision diamond 34 when CHV is not enabled, the logic proceeds to block 40, wherein the IMSI is read from the SIM. If desired, at block 42 the service provider name can be read from the SIM and displayed on the MS 20. Also, if desired at block 44 the mobile directory number can be read from the SIM and displayed.

In any case, the IMSI is transmitted by the MS 20 at block 46 over the CDMA RAN 12 to the MSC 28, which accesses the GSM core infrastructure 14 to undertake authentication of the SIM 24 (and, hence, MS 20) in accordance with GSM principles known in the art. The IMSI can be transmitted in a registration message, an origination message, or a page response message on r-csh. Successful authentication results in registering the SIM 24 (and, hence, MS 20) with the MSC 28 so that the MS 20 can use the CDMA RAN 12. In an embodiment, the authentication precedes displaying information on the Mobile user interface. Therefore, steps 42 and 44 will occur after the authentication procedure terminates successfully.

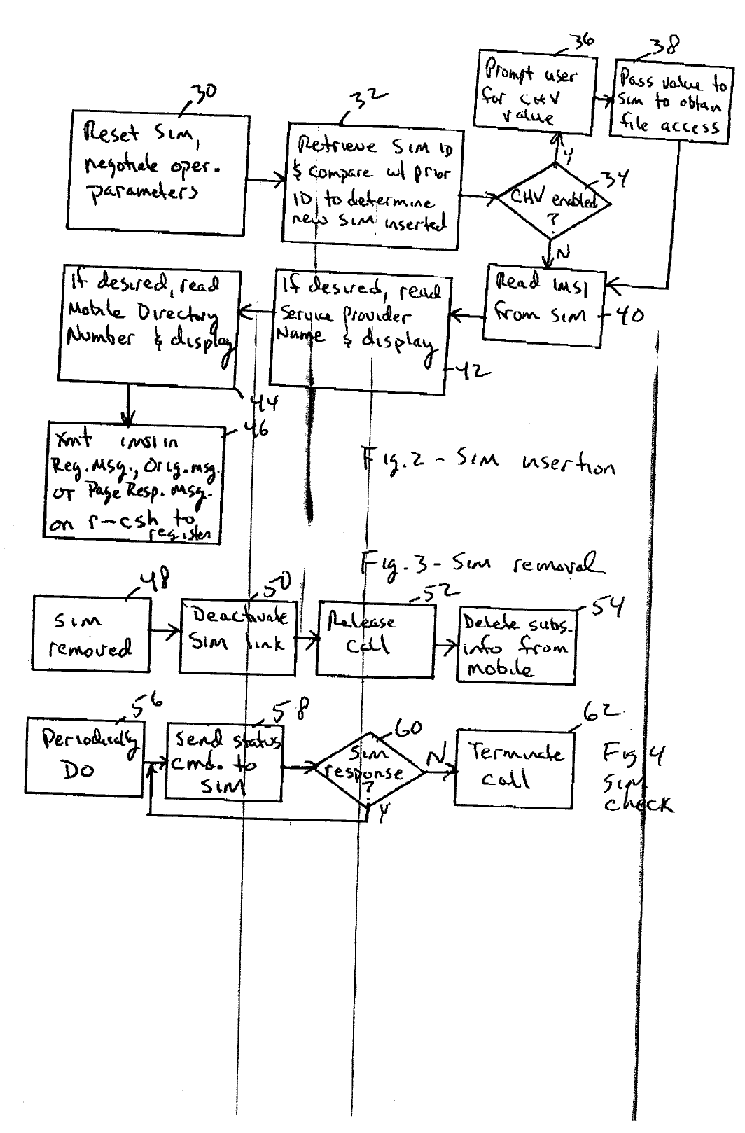

FIG. 3 shows the logic that is followed when the SIM 24 is removed from the MS 20. Commencing at block 48 the SIM is removed, and at block 50 the link between the MS 20 and SIM 24 is deactivated by the MS 20. At block 52, the MS 20 releases any active call, and then deletes subscriber information from its internal memory at block 54.

FIG. 4 shows that the MS 20 periodically (e.g., every thirty seconds) checks for the continued presence of the SIM 24. Commencing at block 56, a DO loop periodically is entered, wherein the MS 20 sends a status command to the SIM at block 58. At decision diamond 60 the MS 20 determines whether the SIM responded, and if not, any active call is terminated at block 62.

In addition to the above logic, the MS 20 with SIM 24 can permit a user to query stored SMS. When the MS 20 transmits an SMS, it preferably also transmits the service center address. If desired, GSM subscription services such as the above-mentioned abbreviated and fixed dialing numbers, advice of charge, etc. can also be supported.

While the particular SYSTEM AND METHOD FOR USING CDMA MOBILE WITH GSM CORE INFRASTRUCTURE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A code division multiple access (CDMA) mobile station (MS), comprising:
a radio circuit configured to communicate with a CDMA radio access network (RAN) using CDMA protocol; and
a subscriber circuit configured to communicate with a GSM subscriber identity module (SIM) to permit the MS to authenticate itself with a GSM core infrastructure, whereby use of the CDMA RAN with the GSM core infrastructure is facilitated.

2. The MS of claim 1, further comprising the SIM.

3. The MS of claim 2, wherein the MS reads at least one identifier from the SIM upon engagement of the SIM with the MS.

4. The MS of claim 3, wherein the identifier is an International Mobile Subscriber Identity (IMSI).

5. The MS of claim 4, wherein the IMSI is transmitted by the MS in at least one message.

6. The MS of claim 5, wherein the message is a registration message.

7. The MS of claim 5, wherein the message is an origination message.

8. The MS of claim 5, wherein the message is a page response message.

9. The MS of claim 1, wherein the MS selectively displays at least one service provider name.

10. The MS of claim 1, wherein the MS selectively displays at least one mobile directory number.

11. The MS of claim 2, wherein the MS permits a user to use the MS only if the user inputs a predetermined verification value to the MS.

12. The MS of claim 2, wherein the MS terminates a call upon removal of the SIM from the MS.

13. The MS of claim 12, wherein the MS deletes subscriber information upon removal of the SIM from the MS.

14. The MS of claim 2, wherein the MS periodically checks for the presence of the SIM in the MS and terminates a call when the MS determines that the SIM is no longer engaged with the MS.

15. The MS of claim 1, wherein the MS uses cdma2000 principles.

16. A method for facilitating the use of a CDMA RAN with a GSM core infrastructure, comprising:
engaging a SIM with a CDMA MS;
transmitting at least one IMSI stored on the SIM to an MSC using a CDMA RAN;
using the IMSI, authenticating the SIM with a GSM core infrastructure; and
based on the authenticating act, registering the MS with SIM with the MSC.

17. The method of claim 16, further comprising transmitting the IMSI in at least one message.

18. The method of claim 17, wherein the message is a registration message.

19. The method of claim 17, wherein the message is an origination message.

20. The method of claim 17, wherein the message is a page response message.

21. The method of claim 16, comprising selectively displaying at least one service provider name on the MS.

22. The method of claim 16, comprising selectively displaying at least one mobile directory number on the MS.

23. The method of claim 16, comprising permitting a user to use the MS only if the user inputs a predetermined verification value to the MS.

24. The method of claim 16, comprising terminating a call upon removal of the SIM from the MS.

25. The method of claim 24, comprising deleting subscriber information upon removal of the SIM from the MS.

26. The method of claim 16, comprising periodically determining whether the SIM is engaged with the MS and terminating a call when it is determined that the SIM is no longer engaged with the MS.

27. The method of claim 16, wherein the MS uses cdma2000 principles.

28. A system for facilitating the use of a CDMA RAN with a GSM core infrastructure, comprising:
an MSC communicating with the CDMA RAN using CDMA protocol, the MSC also communicating with the GSM core infrastructure using GSM protocol;
at least one MS communicating with the CDMA RAN and having a registration in the GSM core infrastructure; and
at least one SIM detachably engageable with the MS for authenticating the MS with the GSM core infrastructure.

29. The system of claim 28, wherein the MS reads at least one identifier from the SIM upon engagement of the SIM with the MS.

30. The system of claim 29, wherein the identifier is an International Mobile Subscriber Identity (IMSI).

31. The system of claim 30, wherein the IMSI is transmitted by the MS in at least one message.

32. The system of claim 31, wherein the message is a registration message.

33. The system of claim 31, wherein the message is an origination message.

34. The system of claim 31, wherein the message is a page response message.

35. The system of claim 28, wherein the MS selectively displays at least one service provider name.

36. The system of claim 28, wherein the MS selectively displays at least one mobile directory number.

37. The system of claim 28, wherein the MS permits a user to use the MS only if the user inputs a predetermined verification value to the MS.

38. The system of claim 28, wherein the MS terminates a call upon removal of the SIM from the MS.

39. The system of claim 38, wherein the MS deletes subscriber information upon removal of the SIM from the MS.

40. The system of claim 28, wherein the MS periodically checks for the presence of the SIM in the MS and terminates a call when the MS determines that the SIM is no longer engaged with the MS.

41. The system of claim 28, wherein the MS uses cdma2000 principles.
